(19) United States
(12) Patent Application Publication
(10) Pub. No.: US 2008/0051991 A1
(43) Pub. Date: Feb. 28, 2008

(54) ROUTE PLANNING SYSTEMS AND TRIGGER METHODS THEREOF

(75) Inventors: Shao-Ting Lee, Taipei County (TW); Hsin-Chung Yeh, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/768,938

(22) Filed: Jun. 27, 2007

Related U.S. Application Data
(60) Provisional application No. 60/823,514, filed on Aug. 25, 2006.

(51) Int. Cl. G01C 21/30

(52) U.S. Cl. 701/209

(57) ABSTRACT

A route planning triggering method is implemented in a route planning device and includes the following steps. An image is captured through an image capture device coupled to the route planning device. The position information of a geographical location is automatically generated from the captured image for planning a route to the location.

### CROSS REFERENCE TO RELATED APPLICATIONS

This application claims the full benefit and priority of provisional U.S. Patent Application Ser. No. 60/823,514, filed Aug. 25, 2006, entitled “Automatic Route Planning With A Camera-Enabled Navigation Device”, and incorporates the entire contents of said application herein.

### BACKGROUND OF THE INVENTION

1. Field of the Invention

The invention relates to computer techniques, and more particularly to route planning systems.

2. Description of the Related Art

GPS is widely used as a navigation device in cars, airplanes, ships, and other conveyances. A GPS receiver cooperates with a digital map to guide a user to any destination identifiable through address input. Input of addresses to a navigation device, however, is troublesome and time consuming. Although a GPS receiver may provide a keyboard, a touch screen, or other means for typing or verbally dictating an address, input of addresses to a navigation device may still be troublesome due to a lengthy address or similar.

### BRIEF SUMMARY OF THE INVENTION

An aspect of a route planning triggering method is implemented in a route planning device and comprises the following steps. An image is captured through an image capture device coupled to the route planning device. The position information of a geographical location is automatically generated from the captured image for planning a route to the location.

Another aspect of a route planning triggering method is implemented in a route planning device and comprises the following steps.

An image is received, and the position information of a geographical location is automatically extracted therefrom and recognized for planning a route to the location.

An aspect of a route planning device comprises an image capture device and a processor coupled thereto. The image capture device captures an image. The processor automatically generates position information of a geographical location from the captured image and planning a route to the location.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary embodiment of a navigation system;

FIG. 2 is a schematic view showing a planned route on a digital map;

FIG. 3 is a block diagram of an exemplary embodiment of a navigation device;

FIG. 4 is a flowchart showing an exemplary embodiment of route planning triggering method;

FIG. 5A shows a captured image with an exemplary 2-dimensional bar code;

FIG. 5B shows another captured image with another exemplary 2-dimensional bar code; and

FIG. 5C shows still another captured image with another exemplary 2-dimensional bar code.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Route planning systems and triggering methods thereof are provided in exemplary embodiments organized as:

1. Navigation system

2. Hardware configuration

3. Route planning triggering methods

4. Route planning

5. Variations

6. Conclusion

1. Navigation System

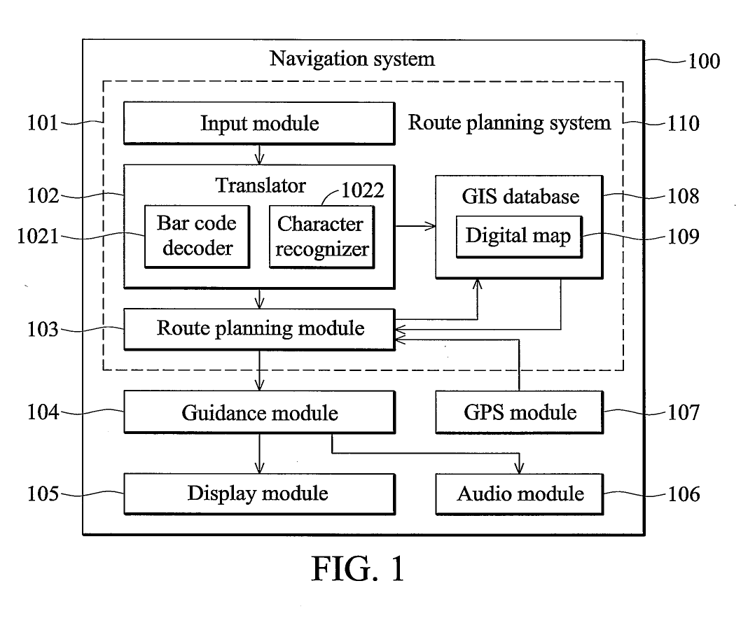

With reference to FIG. 1, navigation system 100 comprises route planning system 110. Geographic information system (GIS) database 108 comprises a digital map 109. Input module 101 receives image data with location information, which may be captured by an image capture device, such as a digital camera. Translator 102 generates position information from image data 220 received by input module 101. Image processing, barcode decoding, character recognition may be performed by translator 102 to generate the position information. For example, bar code decoder 1021 and character recognizer 1022 in translator 102 respectively decode bar codes and identify printed text. Translator 102 may comprise more or less modules for converting image data to position information.

Route planning module 103 receives position information of a point of origin (such as the current location of navigation system 100) and a destination and accordingly determines and stores a route on map 109 from the point of origin to the destination. Global positioning system (GPS) module 107 may provide current geographical coordinates of a GPS receiver as the point of origin to route planning module 103. The original and destination location information, as well as a middle location therebetween, may be retrieved from images through translator 102.

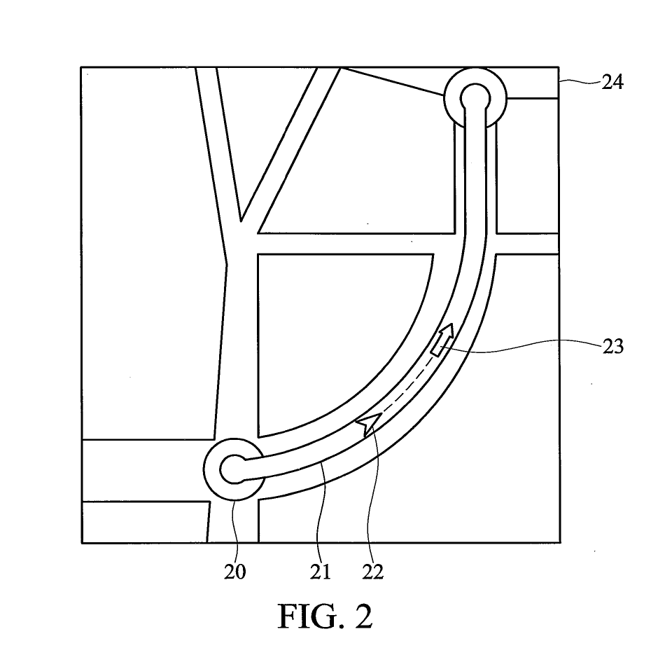

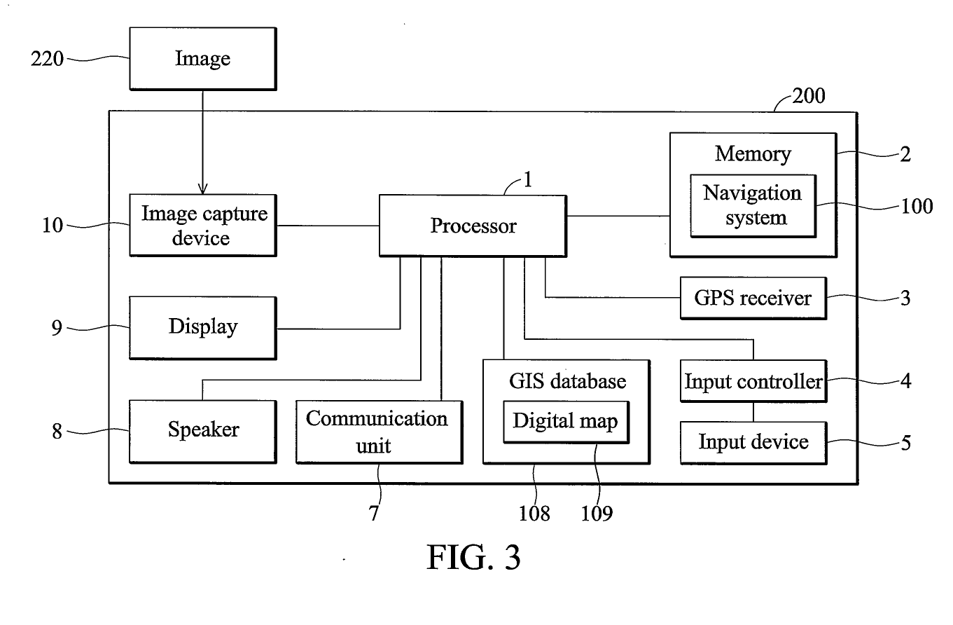

Guidance module 104 guides a user to along the determined route by providing visible and audible signals. For example, with reference to FIG. 2, guidance module 104 directs display module 105 to show the present location of a moving object 22 representing system 100 along with a determined route 21 from point 20 to point 24 on a display (such as display 9 in FIG. 3). Guidance module 104 sets a guide object 23 guiding the path and direction of the moving object 22 on route 21. Additionally, guidance module 104 directs audio module 106 to guide the traveling path and the direction of the moving object 22 with audible signals through a speaker (such as speaker 8 in FIG. 3).

Some components of system 100 may be implemented by circuits or computer programs executed in an electronic device, such as an in-car or handheld navigation device, a personal digital assistant (PDA), a notebook computer, or a mobile phone. For example, input module 101, translator 102, and route planning module 103 may comprise computer programs executed by a processor (such as processor 1 in FIG. 3). Input module 101 may be a portion of an image capture device (such as image capture device 10). An exemplary embodiment of an electronic device implementing the navigation system 100 is given in the following.

2. Hardware Configuration

With reference to FIG. 3, an embodiment of a route planning system and the triggering method thereof may be implemented in electronic device 200 or other devices. The electronic device 200 may comprise a mobile phone, a personal digital assistant (PDA), a laptop computer, a tablet personal computer (PC), or any other device equipped with a display and route planning functions. Preferably, electronic device 200 comprises an embedded system with limited resources.

In electronic device 200, processor 1 loads system 100 to memory 2. Processor 1 controls operation of the entire system as it fetches and executes software codes stored in memory 2. Input controller 4 detects states of input device 5 and provides input signals accordingly to processor 1. Input device 5 may comprise a keypad, a touch panel, a touch display, and/or a voice control device. GPS receiver 3 receives GPS signals from satellites, calculates and provides the current GIS coordinates of device 200. Image capture device 10 may comprise lens, image sensors, and signal processing units. The point of origin information may be retrieved from GPS receiver 3 or image capture device 10. The destination location information may be retrieved from image capture device 10 or other input devices. Memory 2 may comprise a plurality of memory devices including a random access memory (RAM) and nonvolatile memories, such as a hard disk, flash memory, or others.

Communication unit 7 receives data from and transmits data to an external device through a cabled or wireless communication channel. For example, communication unit 7 receives image data with position information as the destination location information. Communication unit 7 may comprise infrared, radio frequency (RF), Bluetooth, or other transceiver. Additionally, when the method is embodied in a mobile phone, communication unit 7 can be a cellular MODEM unit, such as a GSM/GPRS or W-CDMA communication module, which communicates with the cellular network in compliance with the GSM/GPRS or W-CDMA standards.

Speaker 8 outputs audio signals. Display 9 shows visible information. Image capture device 200 captures images to be stored in memory 2. Image capture device 200 may comprise a camera including lens, an image sensor (such as a CMOS or CCD sensor chip), an analog/digital converter (ADC), and a digital signal processor (DSP). Display 9 may comprise a liquid crystal display (LCD), an organic light emitting diode (OLED) display, or others.

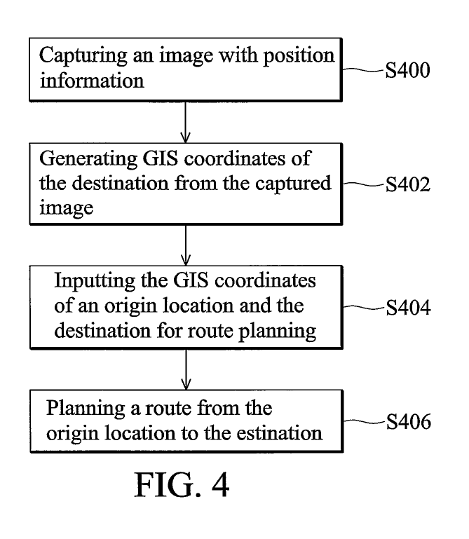

In some embodiments of the electronic device, two components (such as processor 1 and memory 2, or processor 1 and input controller 4) may be integrated into a single chip. An embodiment of a method for triggering route planning implemented in electronic device 200 is shown in FIG. 4.

3. Route Planning Triggering Methods

With reference to FIG. 4, processor 1 directs image capture device 200 to capture an image comprising position information, such as the site name, an address and the coordinates (latitude and longitude) of a destination on map 109 (step S400). More position information (such as a phone number related to the destination) may be included in the image and utilized for locating a destination on map 109. The position information on the image may be text or encoded as bar codes, such as 1-dimensional, stacked, or 2-dimensional bar codes. Examples of stacked bar codes comprise PDF417. Examples of 2-dimensional bar codes comprise Semacode, QR code, and ShotCode.

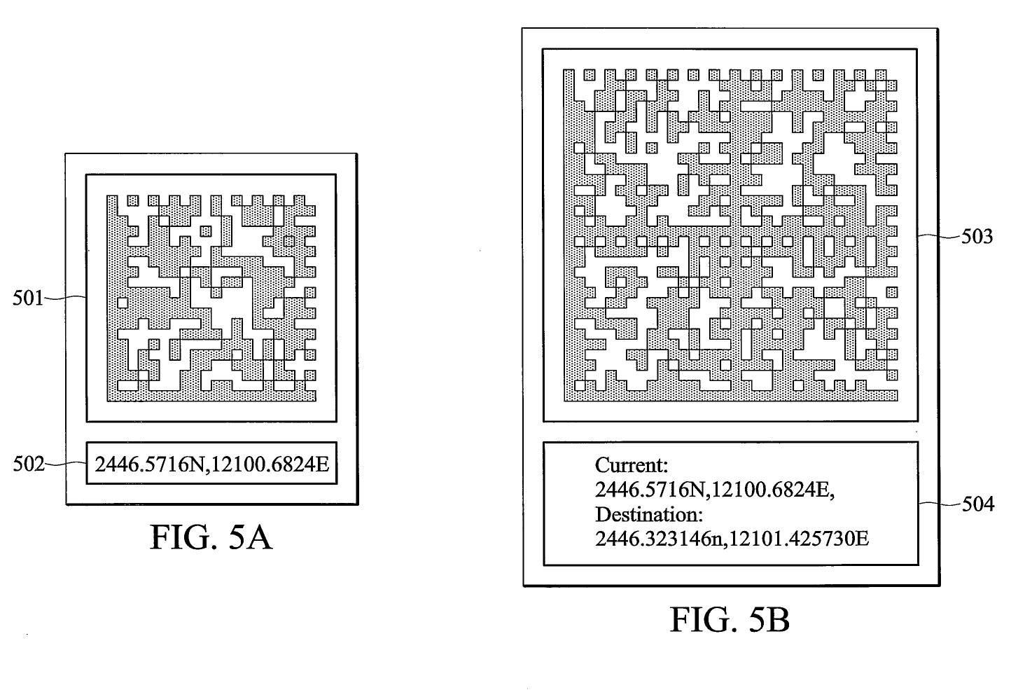

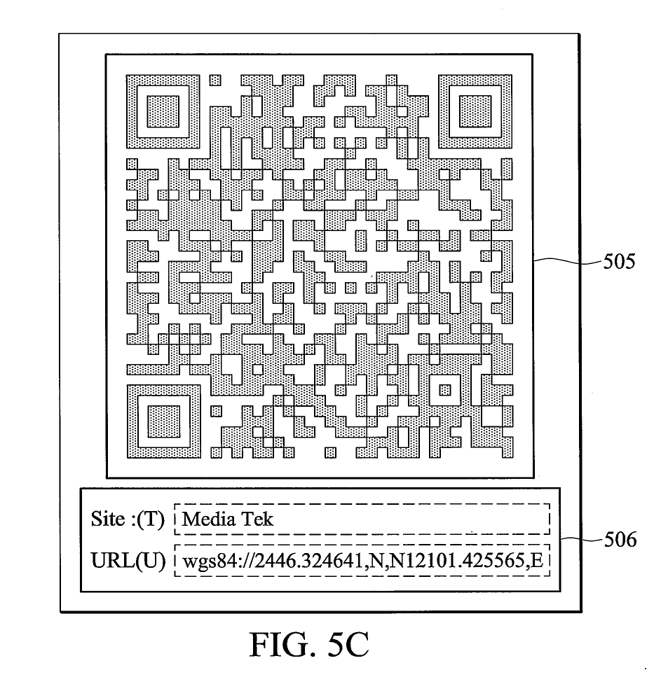

FIGS. 5A˜5C show examples of images comprising 2-dimensional bar codes and text. Bar codes 501 in FIG. 5A indicate a coordinates of (2446.5716N, 12100.6824E) also represented by text in area 502. Bar codes 503 and text in area 504 in FIG. 5B indicate a current coordinates (2446.5716N, 12100.6824E) and a destination coordinates (2446.3231146N, 12101.425730E). Bar codes 505 and text in area 506 in FIG. 5C indicate a site name “MediaTek” with coordinates (2446.324641N, 12101425565E). Note that as bar codes may comprise more information, processor 1 may decode and utilize the information for route planning. Different types of information, however, must be decoded by different identification and decoding modules, such as modules 1021 and 1022.

Processor 1 may automatically execute the following steps in response to a captured image.

Processor 1 generates GIS coordinates of the destination from the captured image (step S402). For example, translator 102 executed by processor 1 generates the GIS coordinates by recognizing characters or decoding bar codes on the captured image. Translator 102 first automatically extracts the position information from the image, recognizes and converts the position information into a predetermined format, such as world geodetic system (WGS) coordinates. For example, with reference to FIGS. 5A˜5C, translator 102 may generate coordinates (2446.5716N, 12100.6824E) as the destination from bar codes 501 in FIG. 5A, or alternatively from text in area 502, coordinates (2446.3231146N, 12101.425730E) from bar codes 503 or text in area 504 in FIG. 5B, and coordinates (2446.324641N, 12101425565E) from bar codes 505 or text in area 506 in FIG. 5C. Bar code decoder 1021 and character recognizer 1022 in translator 102 respectively generate position information from bar codes and printed text.

Note that translator 102 may also identify a point of interest (POI) from the image rather than a coordinate. Translator 102 may generate the GIS coordinates, site name, phone number, or the address of the destination by character recognition or bar code decoding on the captured image. When the image indicates the address of the destination, translator 102 may recognize and utilize the address to locate and retrieve the latitude and longitude of the destination from map 109. When the image shows a phone number related to the destination, translator 102 may recognize and utilize the phone number to locate the latitude and longitude of the destination from map 109. Similarly, other information related to a destination may be utilized to locate the destination.

Processor 1 inputs the GIS coordinates of a point of origin and the destination to route planning module 103 (step S404). GIS coordinates of the point of origin may similarly be generated from a captured image. Alternatively, GPS receiver 3 may provide point of origin GIS coordinates.

Route planning module 103 executed by processor 1 accordingly plans a route from the point of origin to the destination (step S406), stores and outputs the route. Some algorithms, such as the Dijkstra algorithm, A* algorithm, or others, may be utilized for route planning. User profiles may be assigned to find a preferred path.

4. Route Planning

Route planning module 103 executed by processor 1 may determine a shortest path, a fastest path, or a customized path from the point of origin to the destination (step S406). The customized path may be determined with reference to a user profile or suggested paths indicated by the captured image. For example, when the image comprises a suggested route, route planning module 103 recognizes the suggested route in the image, and utilizes the suggested route for the route planning. The suggested route in the image may comprise a plurality of GIS coordinates, such as the current coordinates (2446.5716N, 12100.6824E) in FIG. 5B. Route planning module 103 recognizes the GIS coordinates and plans a route to include a portion or all of the GIS coordinates. Note that the suggested route in the image may comprise other GIS information, such as points of interest (POI), road names, or others.

Route planning module 103 outputs the determined route to guidance module 104. Guidance module 104 guides the user along the route. For example, guidance module 104 may continuously receive the current position of device 200 from GPS module 107 and accordingly update the current location of moving object 22, indicating right turn, a left turn, or a speed by animating the guide object 23 or by audible signals.

5. Variations

Position information extracted from image data may be displayed for confirmation or modification before input to route planning module 103 for route planning. The position information of a point of origin may also be modified.

A camera may be replaced by a bar code scanner or other device, by which position information is generated from bar codes and utilized for route planning. In addition to bar code decoder 1021 and character recognition unit 1022, different modules for recognizing text in different languages or decoding different code formats may be utilized in route planning system 110.

6. Conclusion

Since address input to a navigation device may be difficult, particularly when driving, the method may provide address input assistance for route planning. As much as location information can be captured as image data, a route planning operation may be automatically initiated utilizing the location information. When the image comprises bar codes, the position information may be generated by decoding the bar codes. When the image comprises printed characters, the position information may be generated by identifying the characters. As mobile phones are increasingly equipped with digital cameras, the method can be implemented via software update.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A route planning triggering method, implemented in a route planning device, comprising:
capturing an image through an image capture device coupled to the route planning device;
automatically generating position information of a geographical location from the captured image; and
planning a route involving the location for navigation.

2. The method as claimed in claim 1, wherein the image comprises bar codes, and the method further comprises generating the position information by decoding the bar codes comprised in the image.

3. The method as claimed in claim 2, wherein the bar codes comprise 1-dimemsional, stacked, or 2-dimensional bar codes.

4. The method as claimed in claim 1, wherein the image comprises printed characters, and the method further comprises generating the position information by identifying the characters in the image.

5. The method as claimed in claim 1, wherein the position information comprises latitude and longitude of the location.

6. The method as claimed in claim 1, wherein the image shows the address of the location, further comprising:
recognizing the address; and
retrieving the latitude and longitude of the location utilizing the address.

7. The method as claimed in claim 1, wherein the image shows a phone number related to the location, further comprising:
recognizing the phone number; and
retrieving the latitude and longitude of the location utilizing the phone number.

8. The method as claimed in claim 1, wherein the image comprises a suggested route, further comprising:
recognizing the suggested route in the image; and
utilizing the suggested route for the route planning.

9. The method as claimed in claim 8, wherein the location comprises the destination of the planned route.

10. A route planning triggering method, implemented in a route planning device, comprising:
receiving an image;
automatically extracting and recognizing position information of a geographical location from the image; and
planning a route involving the location for navigation.

11. The method as claimed in claim 10, wherein the image comprises bar codes, and the method further comprises recognizing the position information by decoding the bar codes comprised in the image.

12. The method as claimed in claim 10, wherein the image comprises printed characters, and the method further comprises recognizing the position information by identifying the characters in the image.

13. The method as claimed in claim 10, wherein the image comprises a suggested route, further comprising:
recognizing the suggested route in the image; and
utilizing the suggested route for the route planning.

14. A route planning device, comprising:
an image capture device capturing an image; and
a processor automatically generating position information of a geographical location from the captured image and planning a route involving the location for navigation.

15. The method as claimed in claim 14, wherein the image comprises bar codes, and the processor generates the position information by decoding the bar codes comprised in the image.

16. The method as claimed in claim 14, wherein the image comprises printed characters, and the processor generates the position information by identifying the characters in the image.

17. The method as claimed in claim 14, wherein the position information comprises latitude and longitude of the location.

18. The method as claimed in claim 14, wherein the image comprises a suggested route, and the processor recognizes the suggested route in the image and utilizes the suggested route for the route planning.

19. The method as claimed in claim 14, wherein the route planning device comprises a mobile phone equipped with the image capture device.

20. The method as claimed in claim 14, wherein the route planning device comprises a GPS receiver capable of providing a point of origin of the route.
